(19) United States
(12) Patent Application Publication
(10) Pub. No.: US 2024/0423126 A1
(43) Pub. Date: Dec. 26, 2024

(54) GROUNDS MAINTENANCE VEHICLE

(71) Applicant: EXMARK MANUFACTURING COMPANY INCORPORATED, Beatrice, NE (US)

(72) Inventor: Kevin J. Nelson, Lincoln, NE (US)

(21) Appl. No.: 18/749,844

(22) Filed: Jun. 21, 2024

Related U.S. Application Data
(60) Provisional application No. 63/522,946, filed on Jun. 23, 2023.

(51) Int. Cl. A01D 34/80; A01D 34/64; A01D 69/02; A01D 101/00; F15B 1/26; F15B 15/18; F15B 21/041

(52) U.S. Cl. CPC A01D 34/80; A01D 69/02; F15B 1/26; F15B 15/18; F15B 21/041; A01D 34/64; A01D 2101/00

(57) ABSTRACT

A grounds maintenance vehicle is disclosed. A vehicle frame extends between a first end and a second end in a longitudinal direction. A prime mover is coupled to the vehicle frame. A hydraulic pump assembly is coupled to the vehicle frame, where the hydraulic pump assembly is in mechanical communication with the prime mover. A hydraulic fluid line has a first end and a second end. The first end is fluidly coupled to the hydraulic pump assembly. A drive wheel motor is fluidly coupled to the second end of the hydraulic fluid line. The first end of the hydraulic fluid line extends longitudinally outward from the hydraulic pump assembly in a direction away from the prime mover.

This application claims the benefit of U.S. Provisional Application No. 63/522,946, filed Jun. 23, 2023, the disclosure of which is incorporated by reference herein in its entirety.

### TECHNOLOGICAL FIELD

The present disclosure is generally related to a vehicle. More particularly, the present disclosure is related to a grounds maintenance vehicle.

### SUMMARY

Some embodiments of the technology disclosed herein relate to a grounds maintenance vehicle. A vehicle frame extends between a first end and a second end in a longitudinal direction. A prime mover is coupled to the vehicle frame. A hydraulic pump assembly is coupled to the vehicle frame, where the hydraulic pump assembly is in mechanical communication with the prime mover. A hydraulic fluid line has a first end and a second end. The first end is fluidly coupled to the hydraulic pump assembly. A drive wheel motor is fluidly coupled to the second end of the hydraulic fluid line. The first end of the hydraulic fluid line extends longitudinally outward from the hydraulic pump assembly in a direction away from the prime mover.

In some such embodiments, a minimum longitudinal clearance is defined between the prime mover and hydraulic pump assembly that is less than or equal to 120% of a maximum longitudinal distance from the hydraulic pump assembly across the hydraulic fluid line. Additionally or alternatively, a minimum longitudinal clearance is defined between the prime mover and hydraulic pump assembly that is less than or equal to 110% of a maximum longitudinal distance from the hydraulic pump assembly across the hydraulic fluid line. Additionally or alternatively, a minimum longitudinal clearance is defined between the prime mover and hydraulic pump assembly that is less than or equal to a maximum longitudinal distance from the hydraulic pump assembly across the hydraulic fluid line.

Additionally or alternatively, the first end of the hydraulic fluid line faces a first longitudinal direction and the second end of the hydraulic fluid line faces a second longitudinal direction opposite the first longitudinal direction. Additionally or alternatively, the vehicle frame comprises a first siderail and a second siderail spaced laterally from the first siderail, the prime mover comprises a base, and the base is positioned vertically below most of the length of each of the first siderail and the second siderail. Additionally or alternatively, a standing platform is coupled to the vehicle frame towards the second end, where the standing platform adapted to support a standing operator. Additionally or alternatively, the standing platform has a first end defining a pivot joint coupled to the vehicle frame and the pivot joint is positioned forward of the first end of the hydraulic fluid line.

Additionally or alternatively, a drive wheel is in mechanical communication with the drive wheel motor, and the drive wheel has a drive wheel axis and most of the standing platform is positioned vertically below the drive wheel axis. Additionally or alternatively, a drive wheel is in mechanical communication with the drive wheel motor, and the standing platform is laterally spaced from the drive wheel and longitudinally aligned with the drive wheel. Additionally or alternatively, a cutting deck is coupled to the vehicle frame. The cutting deck has a cutting blade and a housing defining a cutting chamber, and the cutting blade is rotatably disposed in the cutting chamber. Additionally or alternatively, the hydraulic fluid line extends from the hydraulic pump assembly towards the prime mover in the longitudinal direction between the first end and the second end of the hydraulic fluid line. The second end of the hydraulic fluid line extends longitudinally outwardly from the drive wheel motor towards the prime mover.

Additionally or alternatively, the hydraulic fluid line has a flow diameter of greater than 0.5 inches. Additionally or alternatively, a hydraulic filter is in fluid communication with the hydraulic pump assembly. The hydraulic filter is positioned rearwardly of the hydraulic pump. Additionally or alternatively, a hydraulic reservoir is in fluid communication with the pump assembly, and the hydraulic reservoir is positioned above the hydraulic pump assembly. Additionally or alternatively, the hydraulic reservoir is positioned above the hydraulic filter. Additionally or alternatively, no more than 20% of the length of the hydraulic fluid line is within 3 inches of the prime mover. Additionally or alternatively, a drive wheel is in mechanical communication with the drive wheel motor, and the drive wheel has a drive wheel axis and a length, and the first end of the hydraulic fluid line is positioned in the longitudinal direction within 10% of the length of the drive wheel from the drive wheel axis.

Some embodiments relate to a grounds maintenance vehicle having a vehicle frame extending between a first end and a second end in a longitudinal direction. A prime mover is coupled to the vehicle frame. A hydraulic pump assembly is coupled to the vehicle frame, and the hydraulic pump assembly is in mechanical communication with the prime mover. A hydraulic fluid line has a first end and a second end. The first end is fluidly coupled to the hydraulic pump assembly. A drive wheel motor is fluidly coupled to the second end of the hydraulic fluid line. A minimum longitudinal clearance is defined between the prime mover and hydraulic pump assembly that is less than or equal to 120% of a maximum longitudinal distance from the hydraulic pump assembly across the hydraulic fluid line.

In some such embodiments, the first end of the hydraulic fluid line extends longitudinally outward from the hydraulic pump assembly in a direction away from the prime mover. Additionally or alternatively, a minimum longitudinal clearance is defined between the prime mover and hydraulic pump assembly that is less than or equal to 110% of a maximum longitudinal distance from the hydraulic pump assembly across the hydraulic fluid line. Additionally or alternatively, a minimum longitudinal clearance is defined between the prime mover and hydraulic pump assembly that is less than or equal to a maximum longitudinal distance from the hydraulic pump assembly across the hydraulic fluid line.

Additionally or alternatively, the first end of the hydraulic fluid line faces a first longitudinal direction and the second end of the hydraulic fluid line faces a second longitudinal direction opposite the first longitudinal direction. Additionally or alternatively, the vehicle frame has a first siderail and a second siderail spaced laterally from the first siderail, the prime mover has a base, and the base is positioned vertically below most of the length of each of the first siderail and the second siderail. Additionally or alternatively, a standing platform is coupled to the vehicle frame towards the second end, where the standing platform adapted to support a standing operator. Additionally or alternatively, the standing platform has a first end defining a pivot joint coupled to the vehicle frame, where the pivot joint is positioned forward of the first end of the hydraulic fluid line.

Additionally or alternatively, a drive wheel is in mechanical communication with the drive wheel motor, the drive wheel has a drive wheel axis, and most of the standing platform is positioned vertically below the drive wheel axis. Additionally or alternatively, a drive wheel is in mechanical communication with the drive wheel motor, and the standing platform is laterally spaced from the drive wheel and longitudinally aligned with the drive wheel. Additionally or alternatively, a cutting deck is coupled to the vehicle frame, where the cutting deck has a cutting blade and a housing defining a cutting chamber and the cutting blade is rotatably disposed in the cutting chamber. Additionally or alternatively, the hydraulic fluid line extends from the hydraulic pump assembly towards the prime mover in the longitudinal direction between the first end and the second end of the hydraulic fluid line, and the second end of the hydraulic fluid line extends longitudinally outwardly from the drive wheel motor towards the prime mover.

Additionally or alternatively, the hydraulic fluid line has a flow diameter of greater than 0.5 inches. Additionally or alternatively, a hydraulic filter is in fluid communication with the hydraulic pump assembly, where the hydraulic filter is positioned rearwardly of the hydraulic pump. Additionally or alternatively, a hydraulic reservoir is in fluid communication with the pump assembly, and the hydraulic reservoir is positioned above the hydraulic pump assembly. Additionally or alternatively, the hydraulic reservoir is positioned above the hydraulic filter. Additionally or alternatively, no more than 20% of the length of the hydraulic fluid line is within 3 inches of the prime mover. Additionally or alternatively, a drive wheel is in mechanical communication with the drive wheel motor, the drive wheel has a drive wheel axis and a length, and the first end of the hydraulic fluid line is positioned in the longitudinal direction within 10% of the length of the drive wheel from the drive wheel axis.

Some embodiments of the technology disclosed herein relate to a grounds maintenance vehicle having a vehicle frame extending between a first end and a second end in a longitudinal direction. A standing platform is coupled to the vehicle frame towards the second end, where the standing platform adapted to support a standing operator. A prime mover is coupled to the vehicle frame. A first hydraulic pump assembly is coupled to the vehicle frame. The first hydraulic pump assembly is in mechanical communication with the prime mover. A first hydraulic fluid line has a first end and a second end. The first end is fluidly coupled to the first hydraulic pump assembly. The first end of the first hydraulic fluid line extends longitudinally outward from the first hydraulic pump assembly in a direction away from the prime mover. A minimum longitudinal clearance is defined between the prime mover and the first hydraulic pump assembly that is less than or equal to 120% of a maximum longitudinal distance from the first hydraulic pump assembly across the first hydraulic fluid line. A first drive wheel motor is fluidly coupled to the second end of the first hydraulic fluid line. A first drive wheel in mechanical communication with the first drive wheel motor. A second hydraulic pump assembly is coupled to the vehicle frame, and the second hydraulic pump assembly is in mechanical communication with the prime mover. A second hydraulic fluid line has a first end and a second end, and the first end is fluidly coupled to the second hydraulic pump assembly. The first end of the second hydraulic fluid line extends longitudinally outward from the second hydraulic pump assembly in a direction away from the prime mover. A minimum longitudinal clearance is defined between the prime mover and second hydraulic pump assembly that is less than or equal to 120% of a maximum longitudinal distance from the second hydraulic pump assembly across the second hydraulic fluid line. A second drive wheel motor is fluidly coupled to the second end of the second hydraulic fluid line. A second drive wheel is in mechanical communication with the second drive wheel motor.

The above summary is not intended to describe each embodiment or every implementation. Rather, a more complete understanding of illustrative embodiments will become apparent and appreciated by reference to the following Detailed Description and claims in view of the accompanying figures of the drawing.

### BRIEF DESCRIPTION OF THE DRAWINGS

The present technology may be more completely understood and appreciated in consideration of the following detailed description of various embodiments in connection with the accompanying drawings.

FIG. 1 is a first perspective view of an example implementation of the technology disclosed herein in a maintenance vehicle.

FIG. 2 is a second perspective view of an example vehicle consistent with FIG. 1.

FIG. 3 is a partial perspective view of an example vehicle consistent with the present disclosure.

FIG. 4 is another partial perspective view of an example vehicle consistent with the present disclosure.

FIG. 5 is yet another partial perspective view of an example vehicle consistent with the present disclosure.

FIG. 6 is a cross-sectional view of a vehicle that is generally consistent with the technology disclosed herein.

FIG. 7 is a partial bottom view of a vehicle that is generally consistent with the technology disclosed herein.

FIG. 8 is another cross-sectional view of a vehicle that is generally consistent with the technology disclosed herein.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION

In the following detailed description of illustrative embodiments, reference is made to the accompanying figures of the drawing which form a part hereof. It is to be understood that other embodiments, which may not be described and/or illustrated herein, are certainly contemplated.

All headings provided herein are for the convenience of the reader and should not be used to limit the meaning of any text that follows the heading, unless so specified. Moreover, unless otherwise indicated, all numbers expressing quantities, and all terms expressing direction/orientation (e.g., vertical, horizontal, parallel, perpendicular, etc.) in the specification and claims are to be understood as being modified in all instances by the term “about.” The term “and/or” (if used) means one or all of the listed elements or a combination of any two or more of the listed elements. The term “i.e.” is used as an abbreviation for the Latin phrase id est and means “that is.” The term “e.g.” is used as an abbreviation for the Latin phrase exempli gratia and means “for example.”

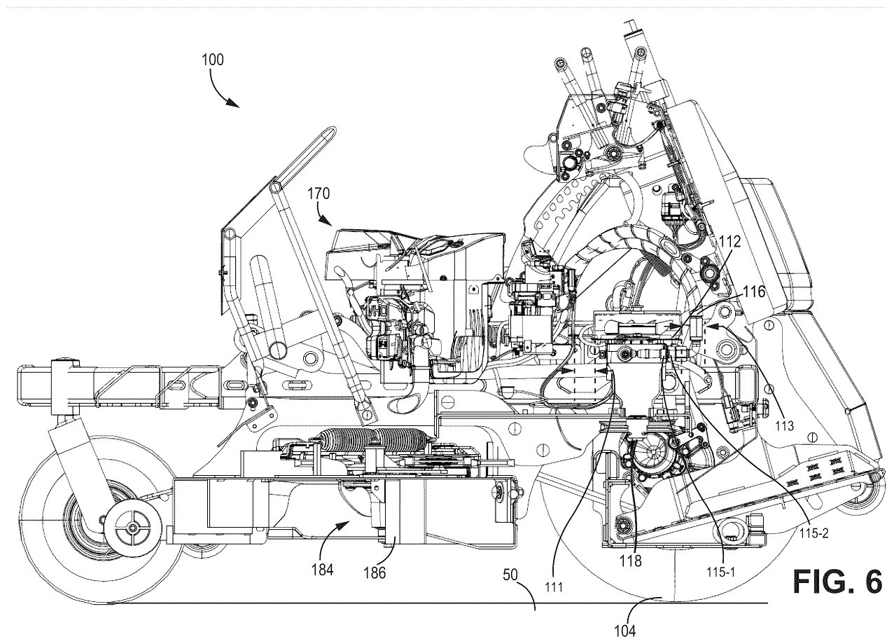

It is noted that the terms “have,” “include,” “comprise,” and variations thereof, do not have a limiting meaning, and are used in their open-ended sense to generally mean “including, but not limited to,” where the terms appear in the accompanying description and claims. Further, “a,” “an,” “the,” “at least one,” and “one or more” are used interchangeably herein. Moreover, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like may be used herein and, if so, are from the perspective shown in the particular figure, or while the vehicle 100 is in an operating configuration (e.g., while the vehicle 100 is positioned such that wheels 102 and 104 rest upon a generally horizontal ground surface 50 as shown in FIG. 6). These terms are used only to simplify the description, however, and not to limit the interpretation of any embodiment described.

Still further, the suffixes “a” and “b” are used throughout this description to denote various left- and right-side parts/features, respectively. However, in most pertinent respects, the parts/features denoted with “a” and “b” suffixes are substantially identical to, or mirror images of, one another. It is understood that, unless otherwise noted, the description of an individual part/feature (e.g., part/feature identified with an “a” suffix) also applies to the opposing part/feature (e.g., part/feature identified with a “b” suffix). Similarly, the description of a part/feature identified with no suffix may apply, unless noted otherwise, to both the corresponding left and right part/feature.

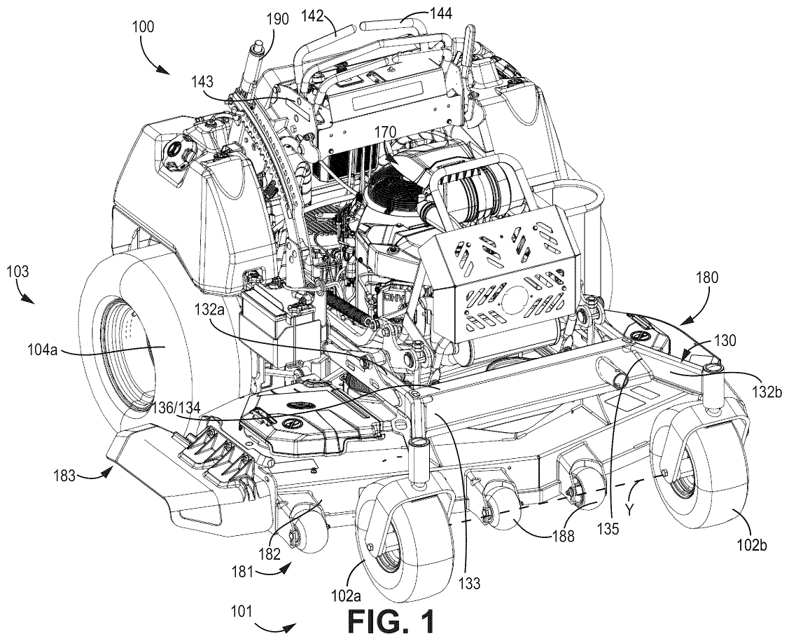

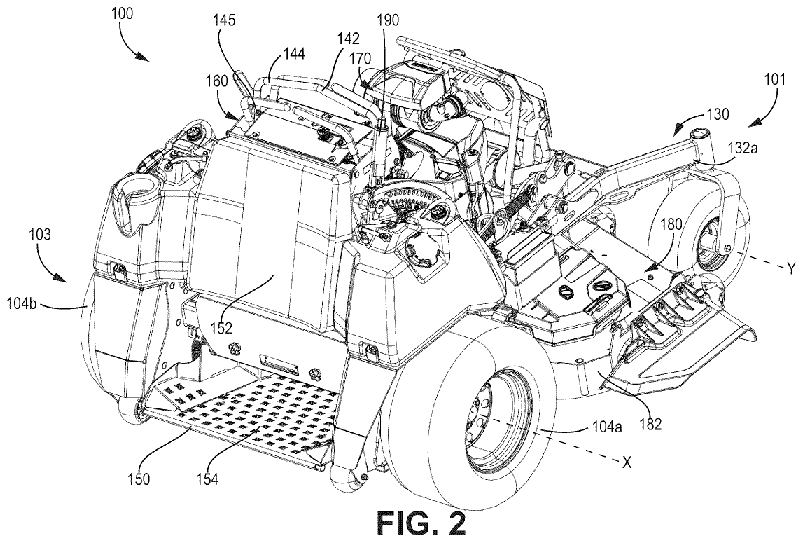

With reference to the figures, where like reference numerals designate like parts and assemblies throughout the several views, FIG. 1 illustrates a perspective view of an example grounds maintenance vehicle 100 in accordance with the present disclosure, which can simply be referred to as a “vehicle”. FIG. 2 depicts a second perspective view of the example vehicle 100 of FIG. 1. The vehicle 100, in the current example, is a standing lawn mower. While embodiments are described herein with respect to such a mower, this disclosure is equally applicable to mowers having alternate configurations (e.g., walk-behind mowers and riding mowers). The embodiments also apply to other types of grounds maintenance vehicles (e.g., aerators, dethatchers, debris management systems, blowers, vacuums, sweepers, general purpose utility vehicles, etc.) without limitation.

The maintenance vehicle 100 generally has a frame 130 (of which a portion is visible) that is configured to support various vehicle components. The frame 130 has a first end 101, which can be a front end, and a second end 103, which can be a rear end. The frame 130 has a plurality of load bearing members such as a siderail 132, which can include a first siderail 132a and second siderail 132b. A “siderail” is defined as a structural, load-bearing component of the vehicle frame 130. A siderail is generally an elongate beam. In some embodiments, siderails are constructed of fabricated sheet metal such as press-formed or roll-formed sheet metal. Siderails can be formed from extruded metal or cast metal in other examples. In some embodiments siderails are each a hollow beam such as structural tubing or a pipe. In some other embodiments the siderails are each a solid beam. In some embodiments the siderail can define at least one channel extending along the length of the siderail, such as an I-beam, H-beam, T-beam, U-beam, or beams having alternate shapes.

The first siderail 132a and the second siderail 132b generally extend longitudinally between the first end 101 and the second end 103 of the frame 130. In some embodiments the first siderail 132a and the second siderail 132b each extend longitudinally from the first end 101 to the second end 103 of the frame 130. The first siderail 132a and the second siderail 132b are generally spaced apart in a lateral direction, which is the width direction of the vehicle 100. In various embodiments, most of the respective lengths of the first siderail 132a and the second siderail 132b are parallel, but in other embodiments the first siderail 132a and the second siderail 132b are non-parallel. The frame 130 has one or more crossbeams 136 that are each fixed to the first siderail 132a and the second siderail 132b. For example, a first crossbeam 134 extends in the lateral direction across the first end 101 of the vehicle 100, which has a first end 133 fixed to the first siderail 132a and a second end 135 fixed to the second siderail 132b. Additional crossbeams can also be coupled to the first siderail 132a and the second siderail 132b, although such crossbeams are not currently visible.

The frame 130 is generally configured to be propelled across the ground surface. In particular, ground engaging members 104 and 102 are rotatably coupled to the vehicle frame 130. Here the ground engaging members are drive wheels 104 and one or more caster wheels 102, but in some embodiments the ground engaging members can be tracks, rollers, and/or other types of wheels. The one or more caster wheels 102 are rotatably coupled to the vehicle frame 130 towards the first end 101 of the vehicle frame 130. The one or more caster wheels 102 are generally undriven wheels that are configured to accommodate directional motion of the maintenance vehicle 100 initiated and directed by the drive wheels 104. The one or more caster wheels 102 are generally freely swivelable about a vertical swivel axis relative to the vehicle frame 130. Each caster wheel 102 has a caster wheel axis Y, which the particular caster wheel 102 rotates around when the caster wheel is oriented in the longitudinal direction, which is in a forward orientation. In some embodiments, including the specific example depicted, the caster wheels 102 mutually define the caster wheel axis Y, such that the caster wheel axis Y is a shared axis that the caster wheels 102 rotate around when oriented in the longitudinal direction. It is possible that, in some embodiments, the caster wheels 102 have separate caster wheel axes when the caster wheels 102 are oriented in the longitudinal direction. In such embodiments, the separate caster wheel axes can be parallel.

The drive wheels 104 are rotatably coupled to the vehicle frame towards the second end 103 of the vehicle frame 130. The drive wheels 104 are generally configured to propel the vehicle 100 over the ground surface 50 and control the vehicle's direction. The drive wheels 104 are generally in mechanical communication with a prime mover 170 (e.g., internal combustion engine or electric motor(s)) that is configured to selectively propel the drive wheels 104 to propel the vehicle 100 across the ground. A left and a right ground engaging drive wheel 104 are rotatably coupled to left and right sides of a rear portion of the vehicle 100, respectively. The drive wheels 104 may be independently powered by the prime mover 170 (e.g., via one or more hydraulic motors, transmissions, or the equivalent) so that they may be driven independently of one another. This permits spin or skid type turning in a zero radius turn manner by rotating one drive wheel 104 in a forward direction while simultaneously rotating the other drive wheel 104 in a reverse direction.

The drive wheels 104 are rotatable about a drive wheel axis X that extends in the lateral direction. In some embodiments, the drive wheel axis X is parallel to the caster wheel axis Y. Although the illustrated vehicle 100 has the drive wheels 104 in the rear, this configuration is not limiting. For example, other embodiments may reverse the location of the wheels, e.g., drive wheels in front and the caster wheel(s) in back. Moreover, other configurations may use different wheel configurations altogether, e.g., a tri-wheel configuration or a conventional front-wheel-steering configuration. Accordingly, other embodiments are possible without departing from the scope of the invention.

The prime mover 170 is coupled to the vehicle frame 130. The prime mover 170 is generally configured to drive the drive wheels 104, which will be described in more detail below. The prime mover 170 can be an internal combustion engine in some embodiments. In some other embodiments the prime mover 170 is an electric motor. In various embodiments, the prime mover 170 has a driveshaft (not currently visible) that is vertically oriented (i.e., a “vertical driveshaft”). The driveshaft is generally in mechanical communication with the drive wheels 104 through a hydraulic transmission system, which will be described in more detail below.

The prime mover 170 is generally configured to be controlled by a user through a control panel 140, for example. The control panel 140 is in operative communication with the prime mover 170. The control panel 140 can have one or more handles 142, 144 that are configured to selectively propel and direct vehicle propulsion. In some embodiments a first handle 142 and a second handle 144 extend outward from the vehicle frame 130 and are each configured to be manually translated relative to the vehicle frame 130 to control operation of the vehicle 100. In the example depicted, the first handle 142 and the second handle 144 are each manually pivotable about a pivot. The first handle 142 has a first pivot 143 (best visible in FIG. 1) and the second handle 144 has a second pivot 145 (visible in FIG. 2). The first handle 142 and the second handle 144 are manually translated about their respective pivots 143, 145 to control operation of the vehicle 100.

In some embodiments, the first handle 142 and second handle 144 can be considered a twin lever control panel, where translation of each handle 142, 144 controls the speed and rotational direction of a corresponding drive wheel 104a, 104b. In this example, translation of the first handle 142 controls a first drive wheel 104a and translation of the second handle 144 controls a second drive wheel 104b. A drive wheel is considered to “correspond” to a particular handle when it is located on the same side of the vehicle, such that a drive wheel on the right side of the vehicle corresponds to a handle on the right side of the vehicle.

The vehicle 100 can have handles with other configurations as well. In some embodiments, a handle can be configured as a steering wheel. The vehicle 100 can have various alternative and additional controls that can be used by the operator to manipulate function of the vehicle 100. The one or more handles 142, 144 and/or various other controls of the control panel 140 are configured to be accessible to the operator positioned on the vehicle 100.

In the current example, the vehicle 100 is configured as a stand-on vehicle. As such, a standing platform 150 (FIG. 2) is coupled to the vehicle frame 130. The standing platform 150 is one or more surface(s) adapted to support the feet of a standing operator. The standing platform 150 is coupled to the vehicle frame 130 towards the second end 103. A support pad 152 can be coupled to the vehicle 100 that is configured to support the body of standing operator positioned on the standing platform 150. In some embodiments, the standing platform 150 is pivotably mounted on the vehicle 100. In such embodiments the standing platform 150 has a deployed position where a platform surface 154 (FIG. 2) extends longitudinally outwardly from the vehicle to receive a standing operator. In some embodiments, the standing platform 150 can also have a stored position that is distinct from the deployed position where the platform surface 154 is pivoted upward or downward in a position that is not configured to receive a standing operator. In alternative embodiments, the vehicle can be a riding vehicle or a walk-behind vehicle. In some other embodiments, the vehicle has a seat to accommodate a seated operator instead of a standing operator. In embodiments where the vehicle has a seat instead of a standing platform, the one or more handles 142, 144 and other system controls are configured to be accessible to the seated operator.

An implement assembly 180 is generally configured to couple to, or be integrally formed with, a grounds maintenance vehicle. The implement assembly 180 is generally configured to perform a maintenance task on a surface, such as the ground surface. The implement assembly 180 has a first implement end 181 and a second implement end 183 and is generally configured for operational interaction with the ground surface. In this example, the first implement end 181 is the front end of the implement assembly 180 and the second implement end 183 is the back end of the implement assembly 180. In the current example, the implement assembly 180 is configured to be disposed between at least a portion of the vehicle frame 130 and the ground surface.

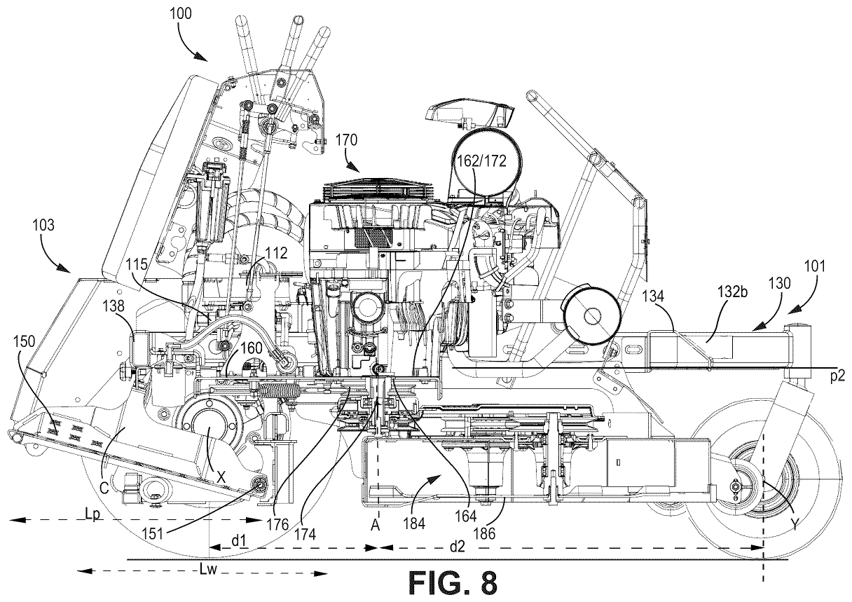

In the current example, where the vehicle 100 includes a lawn mower assembly, the implement assembly 180 is a cutting deck having a housing 182 defining a cutting chamber 184, which is not visible in the current figures, but is visible in the cross-sectional views of FIGS. 6 and 8. Cutting blades 186 are rotatably disposed in the cutting chamber 184. As stated above, other cutting decks (e.g., belly-mounted decks, towed decks, reel units, etc.), as well as other implements, are contemplated within the scope of this disclosure. In the current example, during operation, power is selectively delivered to the cutting chamber 184 by the prime mover 170, whereby the cutting blades 186 rotate at a speed sufficient to sever grass and other vegetation over which the deck passes.

The implement assembly 180 can have a plurality of rollers 188 (e.g., anti-scalp rollers) configured to be disposed between the implement assembly 180 and a ground surface to limit contact between the implement assembly 180 and the ground surface. The plurality of rollers 188 can be configured to obstruct contact between the implement assembly 180 and the ground surface to reduce scalping of the ground surface as the implement assembly 180 translates across the ground surface.

A pre-selected operating height is generally defined between the implement assembly 180 and the ground surface for a specific height-of-cut setting. The operating height can be selected by a user through a height selection tool 190. The height selection tool 190 is configured to change a default vertical operating position of the implement assembly 180 relative to the vehicle frame 130, which changes the pre-selected operating height.

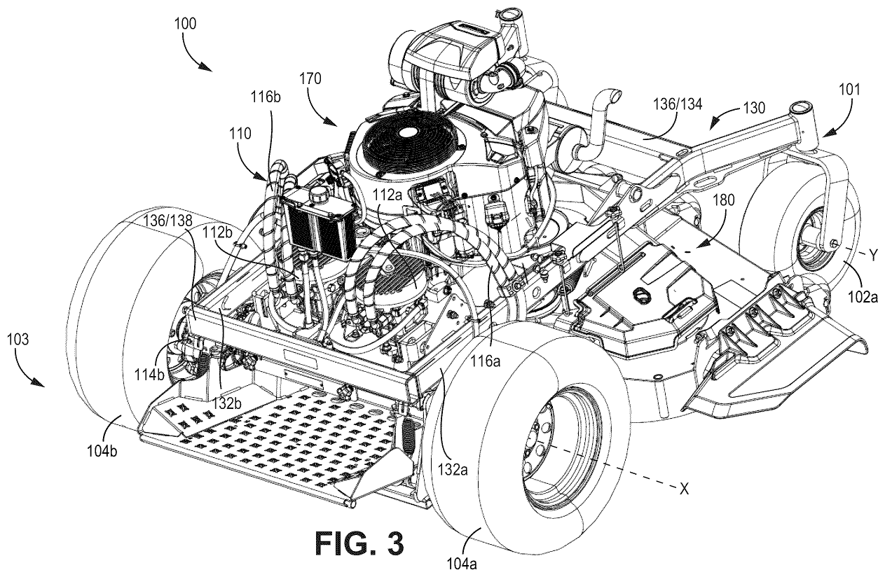

FIG. 3 is a perspective simplified view of an example vehicle 100 consistent with the technology disclosed herein. Various components depicted in the previous figures have been removed for clarity and the descriptions above are generally consistent with the presently depicted figure unless explicitly inconsistent with the current description.

The vehicle 100 has a vehicle frame 130 having a siderail 132, such as a first siderail 132a and second siderail 132b described above. The siderail 132 generally extends longitudinally between the first end 101 and the second end 103 of the frame 130. The first siderail 132a and the second siderail 132b are generally spaced apart in a lateral direction. The frame 130 has one or more crossbeams 136 that extend in the lateral direction and are fixed to the first siderail 132a and the second siderail 132b. The crossbeams 136 include a first crossbeam 134 that extends across the first end 101 of the vehicle frame 130. The crossbeams 136 include a second crossbeam 138 that extends across the second end 103 of the vehicle frame 130. Drive wheels 104 and caster wheel(s) 102 are rotatably coupled to the frame 130. The drive wheels 104 have a drive wheel axis X and the caster wheels 102 each have a separate caster wheel axis or share a caster wheel axis Y.

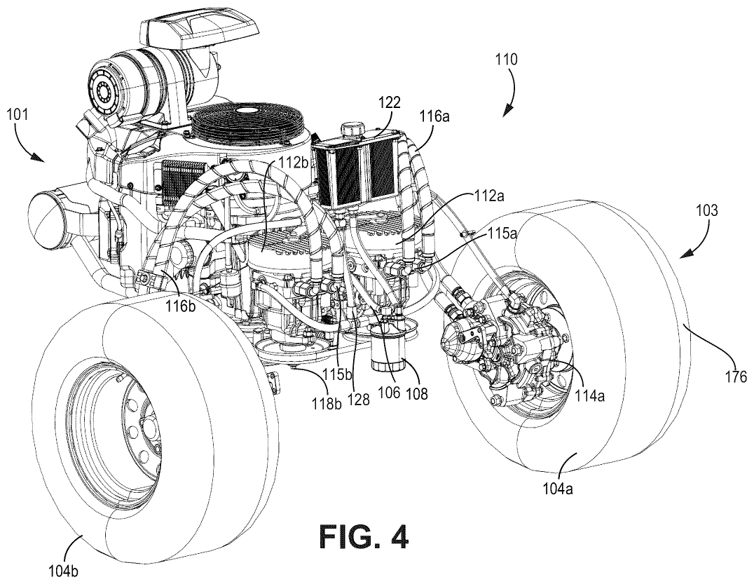

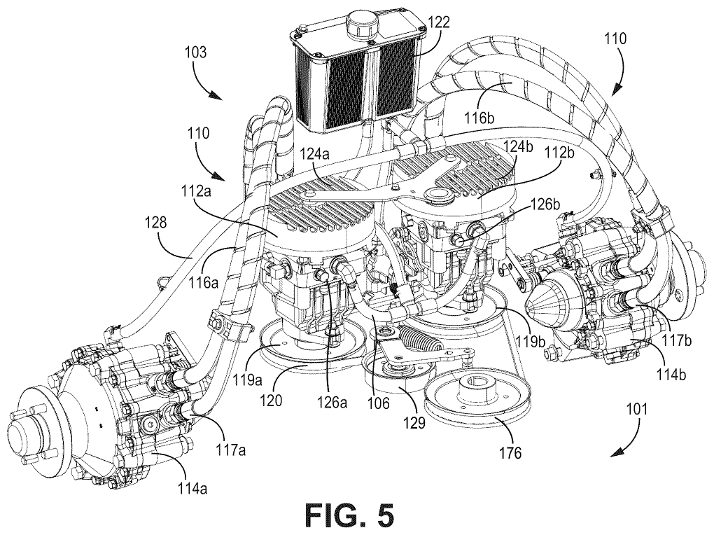

In various implementations of the current technology, the prime mover 170 is mechanical communication with the drive wheels 104a, 104b through a hydraulic transmission system 110. The hydraulic transmission system 110 is configured to transmit mechanical power from the prime mover 170 to each of the drive wheels 104. FIG. 4 is a further simplified perspective view of the prime mover 170 and the hydraulic transmission system 110 of FIG. 3 from the second end 103, and FIG. 5 is a yet further simplified perspective view of the hydraulic transmission system of FIG. 4 from the first end 101 of the vehicle 100. FIGS. 3 and 4 depicts the drive wheels 104a, 104b, and FIG. 5 omits the drive wheels for clarity. The descriptions above are generally consistent with the presently described figures unless explicitly inconsistent with the current description.

The hydraulic transmission system 110 has a hydraulic pump assembly 112 coupled to the vehicle frame 130. The hydraulic pump assembly 112 is in mechanical communication with the prime mover 170. In particular, a driveshaft (not currently visible) of the prime mover 170 is coupled to a drive pulley 176 (visible in FIG. 5) that is mechanically coupled to an input shaft 118 (one of which is partially visible in FIG. 4) of the hydraulic pump assembly 112 via an input pulley 119 disposed on the input shaft 118. A drive belt 120 in particular mechanically couples the drive pulley 176 to the input pulley 119. In various embodiments a tensioner pulley 129 is also mechanically coupled to the drive belt 120. The tensioner pulley 129 is generally configured to maintain appropriate tension on the drive belt 120.

The hydraulic pump assembly 112 is in mechanical communication with a drive wheel motor 114. The drive wheel motor 114 is in mechanical communication with a drive wheel 104. In particular, a hydraulic fluid line 116 extends from the hydraulic pump assembly 112 to the drive wheel motor 114. The hydraulic fluid line 116 has a first end 115 (FIG. 4) fluidly coupled to the hydraulic pump assembly 112 and a second end 117 (FIG. 5) fluidly coupled to the drive wheel motor 114. It is noted that one or both terminal ends of the hydraulic fluid line 116 can define an internal coupling structure (115-1 in FIG. 6) and an external coupling structure (115-2 in FIG. 6) that are each configured to interface with the pump assembly 112 or the wheel motor 114. The internal coupling structure may extend beyond the external coupling structure to protrude into the pump assembly 112 or the wheel motor 114, and the external coupling structure seals to an outer surface of one of the pump assembly 112 or the wheel motor 114 and extends outward therefrom. For purposes of the present disclosure, the “first end 115” and the “second end 117” of the hydraulic fluid line 116 refers to the external coupling structure. When the “first end 115” and the “second end 117” of the hydraulic fluid line is referred to herein, it is noted

It is noted that each hydraulic pump assembly 112 has two hydraulic fluid lines 116 that together form a high-pressure hydraulic circuit between the hydraulic pump assembly 112 and the drive wheel motor 114. The singular reference to the hydraulic fluid line 116 in the present disclosure refers to either or each of the hydraulic fluid lines 116 coupled to a hydraulic pump assembly 112. The drive wheel motor 114 is configured to rotate the corresponding drive wheel 104 (FIG. 4).

The hydraulic transmission system 110 generally has a hydraulic reservoir 122 in fluid communication with the hydraulic pump assembly 112. The hydraulic reservoir 122 is generally configured to store hydraulic fluid and supply hydraulic fluid to the rest of the system 110. In the current example, the hydraulic pump assembly 112 includes a fan 124. The fan 124 can be configured to generate airflow to cool the hydraulic pump assembly 112.

In various embodiments, each drive wheel motor 114 and hydraulic pump assembly 112 are in fluid communication with the hydraulic reservoir 122 through a case drain flow line 128. The case drain flow line 128 defines a fluid flow pathway for leaking hydraulic fluid to the hydraulic reservoir 122. In various embodiments, a fluid supply line 106 extends from the hydraulic reservoir 122 to the hydraulic pump assembly 112. The fluid supply line 106 is configured to supply hydraulic fluid to the hydraulic pump assembly 112. In various embodiments, a hydraulic filter 108 (FIG. 4) is disposed along the fluid supply line 106 extending from the hydraulic reservoir 122 to the hydraulic pump assembly 112. The hydraulic filter 108 can be configured to filter contaminants from the hydraulic fluid, such as particulate matter.

In the current example, the hydraulic filter 108 is positioned rearwardly of the hydraulic pump assembly 112 relative to the vehicle 100. Such a configuration may advantageously facilitate accessibility of the hydraulic filter 108 from the back side of the vehicle 100. Also in the current example, the hydraulic filter 108 is positioned below the hydraulic reservoir 122. The hydraulic reservoir 122 is positioned above the hydraulic pump assembly 112. The hydraulic reservoir 122 is configured to be accessible through the back of the vehicle 100, such as by removing the support pad 152.

The hydraulic transmission system 110 has general functionality consistent with other hydraulic transmission systems known in the art. However, in the currently described technology, the longitudinal orientation of the hydraulic pump assembly 112 is 140°-230°, 160°-210°, or 170°-200° relative to other maintenance vehicles known in the art. Such a change in pump assembly orientation advantageously allows the longitudinal distance between the prime mover 170 and the hydraulic pump assembly 112 to be reduced. As a result, the prime mover 170 can be positioned closer towards the second end 103 of the vehicle 100 compared to a vehicle having a hydraulic pump assembly 112 with the standard orientation known in the art, which may advantageously establish a vehicle center of gravity that is closer to the second end 103 of the vehicle than if the hydraulic pump assembly had such a standard orientation. This design may also advantageously position a vehicle operator closer to the center of gravity of the vehicle compared to designs where the hydraulic pump assembly has such a standard orientation.

In designs consistent with the current technology, the first end 115 (FIG. 4) of the hydraulic fluid line 116 extends longitudinally outward from the hydraulic pump assembly 112 in a direction away from the prime mover 170. Further, the first end 115 of the hydraulic fluid line 116 faces a first longitudinal direction and the second end 117 of the hydraulic fluid line 116 faces a second longitudinal direction opposite the first longitudinal direction, where it is noted that the term “face” or “faces” refers to the direction perpendicular to a plane defined by the relevant end of the hydraulic fluid line 116. The relevant end of the hydraulic fluid line 116 can face a direction that has longitudinal component and a lateral and/or vertical component. For example, it is visible in FIG. 4 that the second end 117 of the hydraulic fluid line 116 faces downward in the vertical direction and rearward in the longitudinal direction, and the longitudinal direction is opposite the first longitudinal direction. The second end 117 of the hydraulic fluid line 116 extends longitudinally outwardly from the drive wheel motor 114 towards the prime mover 170.

Between the first end 115 and the second end 117, the hydraulic fluid line 116 extends from the hydraulic pump assembly 112 towards the prime mover 170 in the longitudinal direction. Between its first end 115 and second end 117, the hydraulic fluid line 116 extends upward from the hydraulic pump assembly 112, and downward towards the drive wheel motor 114. The length of the hydraulic fluid line 116 from the first end 115 to the second end 117 may be greater than where the pump assembly has a conventional orientation. Also, in some embodiments, the longitudinal distance between the first end 115 and the second end 117 may be greater than the distance between the first end and the second end if the pump assembly had a conventional orientation. Further, in some embodiments, the direct, straight-line distance from the first end 115 to the second end 117 may be greater than where the pump assembly has a conventional orientation.

In the current example, the hydraulic pump assembly 112 has a dump valve 126 that is generally configured as a bypass valve to bypass the hydraulic transmission. In the presently disclosed configuration, the dump valve 126 faces towards the prime mover 170 instead of away from the prime mover 170 as it does in some conventional designs. Such a design change may be less intuitive than such conventional designs because the ease of accessibility of the dump valve 126 may be somewhat reduced.

The routing of the hydraulic fluid line 116 may advantageously accommodate flow lines having a relatively larger flow diameter than some existing maintenance vehicles, where the flow diameter is taken across the flow area of a cross-section perpendicular to the length of the hydraulic fluid line. In various embodiments, the hydraulic fluid line 116 has a flow diameter that is greater than 0.5 in. (1.28 cm.). A relative increase in flow diameter may advantageously reduce the likelihood of overheating of system components, which may advantageously extend system life.

In some examples, the hydraulic fluid line 116 may have a minimum spacing from the prime mover 170. Such a configuration may advantageously limit heating of the hydraulic fluid line 116 by the prime mover 170, which may extend the life of the system components and reduce the opportunity for system overheating. For example, in some examples no more than 20%, 10% or even 5% of the length of the hydraulic fluid line 116 is within 5 inches, 4 inches, or even 3 inches of the prime mover 170. In some examples the entire length of the hydraulic fluid line 116 is more than 5 inches, 4 inches or 3 inches from the prime mover 170.

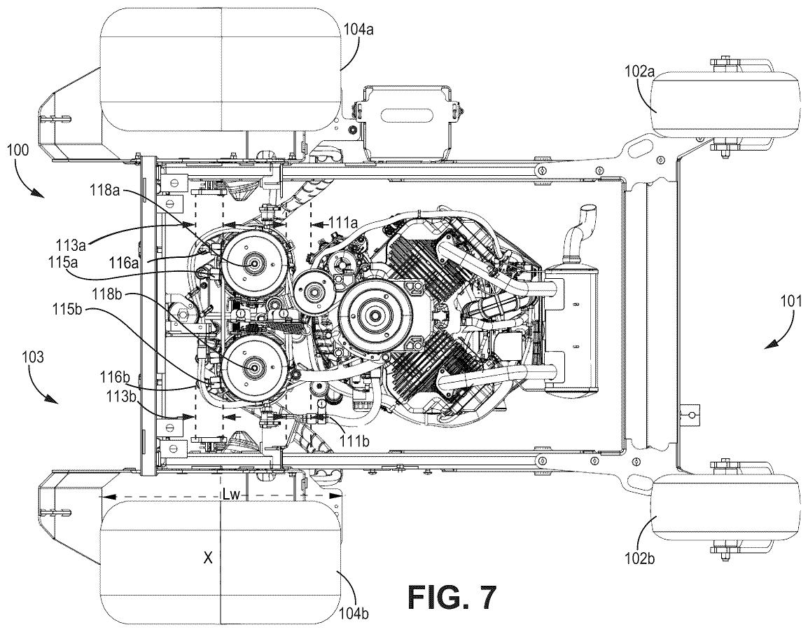

As discussed above, in various examples, the prime mover 170 and the hydraulic pump assembly 112 can be positioned more closely in the longitudinal direction than if the longitudinal orientation of the hydraulic pump assembly 112 were reversed (such as in some conventional configurations). FIG. 6 is a partial cross-sectional view of an example vehicle 100 consistent with figures described above, where the cross-section is taken along the longitudinal length of the vehicle, through the input shaft 118 of a hydraulic pump assembly 112. FIG. 7 is a partial bottom view of the example vehicle 100. The descriptions above are generally consistent with the presently described figures unless explicitly inconsistent with the current description.

A minimum longitudinal clearance 111 is defined between the prime mover 170 and the hydraulic pump assembly 112. A maximum longitudinal distance 113 is defined from the hydraulic pump assembly 112 across the hydraulic fluid line 116. The minimum longitudinal clearance 111 can be less than or equal to 120% of the maximum longitudinal distance 113. In some embodiments, the minimum longitudinal clearance 111 can be less than or equal to 115%, 110%, 105% of the maximum longitudinal distance 113. In some embodiments, the minimum longitudinal clearance 111 can be less than or equal to the maximum longitudinal distance 113.

As is particularly visible in FIG. 7, the first end drive wheel 104 has a length Lw in the longitudinal direction. In some examples, the first end 115 of the hydraulic fluid line 116 is positioned in the longitudinal direction centrally to the drive wheel length Lw. For example, the first end 115 of the hydraulic fluid line 116 can be positioned in the longitudinal direction within 5% or 10% of the length of the drive wheel Lw from the central axis X of the drive wheel.

FIG. 8 depicts a partial cross-sectional view along the longitudinal length of the vehicle 100, through the central axis of the driveshaft 174 and drive pulley 176 of the prime mover 170. The descriptions above are generally consistent with the presently described figure unless explicitly inconsistent with the current description. The vehicle 100 has a mounting structure 160 fixed to the first siderail 132a (visible in FIG. 3) and the second siderail 132b. The prime mover 170 is generally configured to be mounted to the mounting structure 160. In various embodiments, the mounting structure 160 is configured to receive the weight of the prime mover 170 and distribute the weight of the prime mover 170 across the vehicle frame 130 including the first siderail 132a and the second siderail 132b. The mounting structure 160 has a mounting surface 162 that is configured to particularly receive the prime mover 170. In various embodiments, the mounting surface 162 is a surface of the mounting structure 160 that is configured to receive a base 172 of a prime mover 170. The mounting surface 162 is generally positioned laterally between the first siderail 132a and the second siderail 132b. The mounting surface 162 is generally positioned longitudinally between the first end 101 and the second end 103 of the vehicle frame 130.

In the current example, the prime mover 170 has a base 172 that is configured to be contact with the mounting surface 162. In various embodiments the base 172 is fixed to the mounting surface 162 with fastening mechanisms generally known in the art. The mounting surface 162 is generally positioned vertically below the first siderail 132a and the second siderail 132b. The base 172 is generally positioned vertically below the first siderail 132a and the second siderail 132b. Such a configuration may advantageously lower the center of gravity of the vehicle 100. In some embodiments the mounting surface 162 is positioned vertically below an imaginary first siderail plane (not currently visible) and/or an imaginary second siderail plane p2 (FIG. 8) defined by the first siderail 132a and the second siderail 132b. The first siderail plane p1 is a plane defined by the bottom boundary of each of the siderails 132 and the second siderail plane p2 extends centrally through the vertical extension of each of the siderails 132. In various embodiments the mounting surface 162, and therefore the base 172, is positioned vertically below the second siderail plane p2. Such a configuration lowers the center of gravity of the vehicle 100 which may advantageously improve vehicle handling.

In various embodiments the base 172 of the prime mover 170 is positioned vertically below most of the length of each of the first siderail 132a and the second siderail 132b. In particular, in some embodiments a portion of the length of one or both of the first siderail 132a and the second siderail 132b may dip vertically below the mounting surface 162/base 172 such that the distance between the mounting surface 162/base 172 and a horizontal ground surface 50 is greater than the distance between the horizontal ground surface 50 and one or both of the first siderail 132a and the second siderail 132b along that portion of the length. However, in such embodiments, most of the length of each of the first siderail 132a and the second siderail 132b is positioned vertically above the mounting surface 162/base 172. In various embodiments, the mounting surface 162 and the base 172 is positioned vertically below the length of each of the first siderail 132a and the second siderail 132b extending between the caster wheel(s) 102 and the drive wheels 104.

The distance between the base 172 (or mounting surface 162) and a horizontal ground surface 50 may be less than 16 inches in some embodiments. In some embodiments the distance between the base 172 (or mounting surface 162) and the horizontal ground surface 50 may be less than 15 inches in some embodiments. In some embodiments the distance between the base 172 (or mounting surface 162) and a horizontal ground surface 50 is greater than 8 inches, 9 inches, or 10 inches. In some embodiments the distance between the base 172 (or mounting surface 162) and a horizontal ground surface 50 ranges from 12 inches to 15 inches or 13 inches to 14 inches.

In various embodiments, the driveshaft 174 of the prime mover 170 has a driveshaft axis A. The driveshaft 174 extends vertically downward from the base 172 of the prime mover 170. As such, the driveshaft 174 extends vertically downward from the mounting surface 162 of the mounting structure 160. The mounting surface 162 defines a driveshaft opening 164 that is configured to accommodate the driveshaft 174. The driveshaft 174 extends through the driveshaft opening 164.

In various embodiments, the driveshaft of the prime mover 170 is positioned closer to the second crossbeam 138 than the first crossbeam 134 of the vehicle frame 130. In some embodiments the driveshaft axis A can be positioned more closely to the second end 103 than the first end 101 of the vehicle frame 130 in the longitudinal direction. In some embodiments, the driveshaft axis A is positioned closer to the drive wheel axis X than the caster wheel axis Y in the longitudinal direction, which is represented by distances d1 and d2 in FIG. 9. As is visible in FIG. 9, in some embodiments, the driveshaft 174 of the prime mover 170 extends below a horizontal plane C defined by the drive wheel axis X.

In various embodiments the drive wheel axis X is positioned towards the second end 103 of the vehicle frame 130. In various embodiments the drive wheel axis X is positioned between the mounting surface 162 and the standing platform 150 in the longitudinal direction. In such embodiments the drive wheel axis X is positioned between the base 172 and the standing platform 150 in the longitudinal direction.

The standing platform 150 is positioned towards the second end 103 of the vehicle frame 130. In the current example, the standing platform 150 extends rearwardly beyond the drive wheel axis X in the longitudinal direction. The standing platform 150 is generally laterally spaced from each drive wheel 104 (FIG. 2). In particular, the standing platform 150 is positioned between each drive wheel 104 in the lateral direction. In the current examples, the standing platform 150 is longitudinally aligned with the drive wheel 104, meaning that the longitudinal length Lp of the standing platform 150 and the longitudinal length Lw of the drive wheel 104 overlap in the vertical direction, as is visible in FIG. 8.

In various embodiments, in a deployed position, most of the standing platform 150 is configured to be positioned vertically below the drive wheel axis X, meaning that most of the surface area of the standing platform 150 is vertically below the drive wheel axis X. In some embodiments, when in a deployed position, the standing platform 150 is configured to be entirely positioned vertically below the drive wheel axis X. Such a configuration is represented by plane C in FIG. 9. In various embodiments, the drive wheel axis X is positioned between the mounting surface 162 (and therefore the base 172) and most of the deployed standing platform 150 in the vertical direction. In the current example, the standing platform 150 has a first end defining a pivot joint 151 that is pivotably coupled to the vehicle frame 130. The pivot joint 151 can be positioned vertically below the drive wheel axis X. In some embodiments, the pivot joint 151 is positioned vertically below the caster wheel axis Y. In some embodiments, the pivot joint 151 is positioned forward of the first end 115 of the hydraulic fluid line 116 relative to the vehicle 100. In some embodiments, the pivot joint 151 is positioned vertically below the pump assembly 112.

It should also be noted that, as used in this specification and the appended claims, the phrase “configured” describes a system, apparatus, or other structure that is constructed to perform a particular task or adopt a particular configuration. The word “configured” can be used interchangeably with similar words such as “arranged”, “constructed”, “manufactured”, and the like.

All publications and patent applications in this specification are indicative of the level of ordinary skill in the art to which this technology pertains. All publications and patent applications are herein incorporated by reference to the same extent as if each individual publication or patent application was specifically and individually indicated by reference. In the event that any inconsistency exists between the disclosure of the present application and the disclosure(s) of any document incorporated herein by reference, the disclosure of the present application shall govern.

This application is intended to cover adaptations or variations of the present subject matter. It is to be understood that the above description is intended to be illustrative, and not restrictive, and the claims are not limited to the illustrative embodiments as set forth herein.

1. A grounds maintenance vehicle comprising:
a vehicle frame extending between a first end and a second end in a longitudinal direction;
a prime mover coupled to the vehicle frame;
a hydraulic pump assembly coupled to the vehicle frame, wherein the hydraulic pump assembly is in mechanical communication with the prime mover;
a hydraulic fluid line having a first end and a second end, wherein the first end is fluidly coupled to the hydraulic pump assembly and the first end of the hydraulic fluid line extends longitudinally outward from the hydraulic pump assembly in a direction away from the prime mover; and
a drive wheel motor fluidly coupled to the second end of the hydraulic fluid line.

2-4. (canceled)

5. The grounds maintenance vehicle of claim 1, wherein the first end of the hydraulic fluid line faces a first longitudinal direction and the second end of the hydraulic fluid line faces a second longitudinal direction opposite the first longitudinal direction.

6. The grounds maintenance vehicle of claim 1, wherein the vehicle frame comprises a first siderail and a second siderail spaced laterally from the first siderail, the prime mover comprises a base, and the base is positioned vertically below most of the length of each of the first siderail and the second siderail.

7. The grounds maintenance vehicle of claim 1, further comprising a standing platform coupled to the vehicle frame towards the second end, the standing platform adapted to support a standing operator.

8. The grounds maintenance vehicle of claim 7, the standing platform having a first end defining a pivot joint coupled to the vehicle frame, wherein the pivot joint is positioned forward of the first end of the hydraulic fluid line.

9. The grounds maintenance vehicle of claim 7, further comprising a drive wheel in mechanical communication with the drive wheel motor, wherein the drive wheel has a drive wheel axis and most of the standing platform is positioned vertically below the drive wheel axis.

10. The grounds maintenance vehicle of claim 7, further comprising a drive wheel in mechanical communication with the drive wheel motor, and the standing platform is laterally spaced from the drive wheel and longitudinally aligned with the drive wheel.

11. (canceled)

12. The grounds maintenance vehicle of claim 1, wherein between the first end and the second end of the hydraulic fluid line, the hydraulic fluid line extends from the hydraulic pump assembly towards the prime mover in the longitudinal direction, and the second end of the hydraulic fluid line extends longitudinally outwardly from the drive wheel motor towards the prime mover.

13. (canceled)

14. The grounds maintenance vehicle of claim 1, further comprising a hydraulic filter in fluid communication with the hydraulic pump assembly, wherein the hydraulic filter is positioned rearwardly of the hydraulic pump.

15. The grounds maintenance vehicle of claim 14, further comprising a hydraulic reservoir in fluid communication with the pump assembly, wherein the hydraulic reservoir is positioned above the hydraulic pump assembly.

16. The grounds maintenance vehicle of claim 15, wherein the hydraulic reservoir is positioned above the hydraulic filter.

17. The grounds maintenance vehicle of claim 1, wherein no more than 20% of the length of the hydraulic fluid line is within 3 inches of the prime mover.

18. The grounds maintenance vehicle of claim 1, further comprising a drive wheel in mechanical communication with the drive wheel motor, wherein the drive wheel has a drive wheel axis and a length, and the first end of the hydraulic fluid line is positioned in the longitudinal direction within 10% of the length of the drive wheel from the drive wheel axis.

19. A grounds maintenance vehicle comprising:
a vehicle frame extending between a first end and a second end in a longitudinal direction;
a prime mover coupled to the vehicle frame;
a hydraulic pump assembly coupled to the vehicle frame, wherein the hydraulic pump assembly is in mechanical communication with the prime mover;
a hydraulic fluid line having a first end and a second end, wherein the first end is fluidly coupled to the hydraulic pump assembly and wherein a minimum longitudinal clearance is defined between the prime mover and hydraulic pump assembly that is less than or equal to 120% of a maximum longitudinal distance from the hydraulic pump assembly across the hydraulic fluid line; and
a drive wheel motor fluidly coupled to the second end of the hydraulic fluid line.

20. (canceled)

21. The grounds maintenance vehicle of claim 19, wherein a minimum longitudinal clearance is defined between the prime mover and hydraulic pump assembly that is less than or equal to 110% of a maximum longitudinal distance from the hydraulic pump assembly across the hydraulic fluid line.

22. The grounds maintenance vehicle of claim 19, wherein a minimum longitudinal clearance is defined between the prime mover and hydraulic pump assembly that is less than or equal to a maximum longitudinal distance from the hydraulic pump assembly across the hydraulic fluid line.

23-29. (canceled)

30. The grounds maintenance vehicle of claim 19, wherein between the first end and the second end of the hydraulic fluid line, the hydraulic fluid line extends from the hydraulic pump assembly towards the prime mover in the longitudinal direction, and the second end of the hydraulic fluid line extends longitudinally outwardly from the drive wheel motor towards the prime mover.

31. (canceled)

35. The grounds maintenance vehicle of claim 19, wherein no more than 20% of the length of the hydraulic fluid line is within 3 inches of the prime mover.

36. The grounds maintenance vehicle of claim 19, further comprising a drive wheel in mechanical communication with the drive wheel motor, wherein the drive wheel has a drive wheel axis and a length, and the first end of the hydraulic fluid line is positioned in the longitudinal direction within 10% of the length of the drive wheel from the drive wheel axis.

37. A grounds maintenance vehicle comprising:
a vehicle frame extending between a first end and a second end in a longitudinal direction;
a standing platform coupled to the vehicle frame towards the second end, the standing platform adapted to support a standing operator
a prime mover coupled to the vehicle frame;
a first hydraulic pump assembly coupled to the vehicle frame, wherein the first hydraulic pump assembly is in mechanical communication with the prime mover;
a first hydraulic fluid line having a first end and a second end, wherein the first end is fluidly coupled to the first hydraulic pump assembly and the first end of the first hydraulic fluid line extends longitudinally outward from the first hydraulic pump assembly in a direction away from the prime mover, and wherein a minimum longitudinal clearance is defined between the prime mover and first hydraulic pump assembly that is less than or equal to 120% of a maximum longitudinal distance from the first hydraulic pump assembly across the first hydraulic fluid line;
a first drive wheel motor fluidly coupled to the second end of the first hydraulic fluid line;
a first drive wheel in mechanical communication with the first drive wheel motor;
a second hydraulic pump assembly coupled to the vehicle frame, wherein the second hydraulic pump assembly is in mechanical communication with the prime mover;
a second hydraulic fluid line having a first end and a second end, wherein the first end is fluidly coupled to the second hydraulic pump assembly and the first end of the second hydraulic fluid line extends longitudinally outward from the second hydraulic pump assembly in a direction away from the prime mover, and wherein a minimum longitudinal clearance is defined between the prime mover and second hydraulic pump assembly that is less than or equal to 120% of a maximum longitudinal distance from the second hydraulic pump assembly across the second hydraulic fluid line;
a second drive wheel motor fluidly coupled to the second end of the second hydraulic fluid line; and
a second drive wheel in mechanical communication with the second drive wheel motor.
